(19) United States
(12) Patent Application Publication
(10) Pub. No.: US 2005/0010776 A1
(43) Pub. Date: Jan. 13, 2005

(54) Optically variable devices with encrypted embedded data for authentication of identification documents

(76) Inventors: Leo M. Kenen, Bedford, MA (US); Robert Jones, Andover, MA (US); Robert T. Durst JR., Dunstable, MA (US)

Correspondence Address: DIGIMARC CORPORATION, 9405 SW GEMINI DRIVE, BEAVERTON, OR, 97008, US

(21) Appl. No.: 10/816,175

(22) Filed: Mar. 31, 2004

Related U.S. Application Data
(60) Provisional application No. 60/459,284, filed on Mar. 31, 2003.
(60) Provisional application No. 60/463,659, filed on Apr. 16, 2003.
(60) Provisional application No. 60/488,536, filed on Jul. 17, 2003.
(60) Provisional application No. 60/494,660, filed on Aug. 8, 2003.
(60) Provisional application No. 60/463,660, filed on Apr. 16, 2003.

(51) Int. Cl. H04L 9/00

(52) U.S. Cl. 713/176

(57) ABSTRACT

Systems and methods are disclosed for providing security to an identification document having at least one storage element capable of storing information. An encryption key is provided, the encryption key comprising a public key and a private key. An optically variable device (OVD) in a machine readable format is created, the OVD associated with the public key. A payload of data is generated for storage in the storage element. At least a portion of the payload of data is encrypted with the private key, and the encrypted payload of data is transmitted to at least one location on the identification document. At least a portion of the data payload can be based on data that is randomly selected from data stored in the storage element or that is encrypted from data that is stored in the storage element. The storage element can comprise an optically variable device (OVD), optical storage media, hologram, KINEGRAM, Exelgram, Pixelgram, three dimensional bar code, a two dimensional bar code, a magnetic stripe, and a chip. Transmitting the encrypted payload can comprise at least one of embedding, digitally watermarking, printing, and encoding encrypted data in at least one location on the identification document.

### RELATED APPLICATION DATA

This application claims priority to the following United States Provisional Applications:
“Optically Variable Devices with Embedded Data for Authentication of Identification documents,” Ser. No. 60/459,284, Attorney Docket Number P0816D, inventor Robert Jones, filed Mar. 31, 2003;
“Optically Variable Devices with Encrypted Embedded Data for Authentication of Identification Document,” Ser. No. 60/463,659, inventors Robert Jones and Leo Kenen, filed Apr. 16, 2003;
“Uniquely Linking Security Elements in Identification Documents,” Ser. No. 60/488,536, Attorney Docket Number P0853D, inventors Robert Durst, Robert Jones, and Leo Kenen, filed Jul. 17, 2003;
“Hologram Manufacturing Method Employing Selective Placement of Refractive Materials,” Ser. No. 60/494,660, Attorney Docket Number P0865D, inventor Robert Jones, filed Aug. 8, 2003;
“Methods and Devices for Providing Three Dimensional Bar Codes”, Ser. No. 60/463,660, Attorney Docket Number P0824D, inventors Robert Jones and Brian Labrec, filed on Apr. 16, 2003.

This application is also related to the following U.S. patent applications and issued patents:
“Watermarking Holograms,” Ser. No. 09/741,779, inventors Stephen K. Decker, Hugh L. Brunk, and J. Scott Carr, filed Dec. 21, 2000;
“Digitally Watermarking Holograms for Use With Smart Cards,” Ser. No. 09/923,732, inventors Neil Lofgren, Stephen K. Decker, Hugh L. Brunk, and J. Scott Carr (now issued U.S. Pat. No. 6,608,911, issued on Aug. 19, 2003);
“Digital watermarks and methods for security documents,” U.S. Pat. No. 6,345,105, inventor Geoffrey B. Rhoads, issued Feb. 5, 2002;
“Methods and systems for watermark processing of line art images,” U.S. Pat. No. 6,449,377, inventor Geoffrey B. Rhoads, issued Sep. 10, 2002′ and
“Identification Document,” U.S. Pat. No. 6,066,594, inventors Valerie E. Gunn and Janet Schaffner, issued May 23, 2000.

Each of the above U.S. patent applications and issued patents is hereby incorporated by reference in its entirety.

### TECHNICAL FIELD

The invention relates to authentication of documents, such as secure or identification documents, and particularly relates to the use of optically variable devices on such documents, including Optically Variable Devices with Encrypted Embedded Data for Authentication of Identification Documents.

### BACKGROUND AND SUMMARY

Digital watermarking is a process for modifying physical or electronic media to embed a machine-readable code into the media. The media may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by altering the host media signal. The reading component analyzes a suspect signal to detect whether a watermark is present. In applications where the watermark encodes information, the reader extracts this information from the detected watermark.

Several particular watermarking techniques have been developed. The reader is presumed to be familiar with the literature in this field. Particular techniques for embedding and detecting imperceptible watermarks in media signals are detailed in co-pending application Ser. No. 09/503,881 and U.S. Pat. No. 5,862,260, each of which is incorporated by reference in its entirety.

Digital watermarks can be exploited in a variety of applications, including authenticating electronic and physical objects and counterfeit deterrence. They may also be used in conjunction with other security technologies.

Optically Variable Devices (OVDs) are another type of technology used in security applications. OVDs encompass a class of devices that includes Diffractive Optically Variable Image Devices (DOVIDs), such as holograms. Within the field of holography, there are a variety of types of DOVIDs including, for example, Exelgram™, Kinegram™, and Pixelgram™ DOVIDs. This document uses the term hologram to encompass many different devices but including at least diffractive devices, including DOVIDs manufactured on metallized or clear film, by the replication of a surface relief pattern (e.g., embossed hologram), through laser exposure (e.g., photopolymer holograms), or other known processes. The state of the art of manufacturing holograms offers several methods for creating a diffraction pattern and mass reproduction of them. The reader is presumed to be familiar with the various methods for creation of DOVIDS and other OVDs.

Previous U.S. patent application Ser. No. 09/741,779 (Publication 2002-0080992), Ser. No. 09/923,762 (Publication 2002-0080994), and Ser. No. 10/282,908 (Publication 20030128862), which are hereby incorporated by reference, describe how to embed auxiliary, machine-readable data in Optically Variable Devices (OVDs) such as holograms. One specific example is a digital watermark that carries hidden machine-readable data in a hologram. In addition, these documents describe that the OVD may be used on a secure document, and carry embedded data to authenticate the secure document, either by comparing the embedded data with other data on the document or with data in a database.

The machine readable data embedded in an OVD may be a laser readable structure such as a bar code like structure (e.g., approximately 1 by 5 mm area integrated into the graphic design of a KINEGRAM® OVD by OVD Kinegram AG of Zug, Switzerland, which, when magnified appears like a one-dimensional bar code that is machine readable and carries around 64 bits of data). Alternatively, the machine readable data may be a digital watermark embedded and read using the methods described in the documents referenced above.

We have found that KINEGRAMS and other OVDs can be adapted to provide even further levels of document authentication. For example, we can embed the graphical image of an OVD such as a KINEGRAM with a digital watermark, where the watermark itself is readable using, for example, other digital watermarks embedded within other graphical elements on the identification document or using other machine readable information stored elsewhere in or on the identification document. This can link the OVD to other information on the identification document and make detection of fraud more apparent.

In a first aspect, this disclosure describes the use of OVDs on secure documents, and specifically a type of OVD called a KINEGRAM® OVD that carries machine readable data. The KINEGRAM® OVD carries laser readable data such as a bar code like structure integrated into the design and/or a digital watermark. For identification document applications such as ID cards, the auxiliary data embedded in the OVD associates the OVD with the issuer of the identification document and/or to the identification document itself.

To authenticate the document, a scanner captures an image of the OVD, extracts the embedded data, and compares it with expected data (such as an issuer identifier) and/or other data on the document (e.g., ID card) to check that the document is valid and unaltered. The other data on the identification document may include printed text (e.g., scanned, OCR converted to text representation, and compared) digital watermarks embedded in background art and/or photos, bar codes, RF ID tags, integrated circuit chips, magnetic ink, magnetic stripe, etc.

The expected data may be fixed in the verification device or looked up in a local or remote database. The auxiliary data embedded in the identification document can be used as an index to a database entry where the expected data associated with the issuer or the particular identification document is stored.

Biometric data verification may also be used to associate the bearer of the identification document with the document or information indexed in a database. The biometric data (or a hash of it) may be stored as auxiliary data embedded in the OVD or elsewhere in the identification document, and later extracted and compared with biometric data captured from the bearer or looked up from a database.

In a second aspect, the invention provides methods for integrating digital watermarks into holograms, watermarked hologram structures, and related applications. One aspect of the invention is a method of embedding a digital watermark in an optically variable device. This method creates a watermark image, and then embeds the watermark image into a holographic structure. Such a watermarked holographic structure can be used in connection with an information carrier, such as a smart card, credit card, integrated circuit card, RFID card, magnetic-stripe card, etc. The digital watermark caries information to assist in authenticating the card, the holograph and/or the card holder.

In a third aspect, this disclosure describes adding an additional layer of security to either or both of the first and second aspects described herein by using encryption to transform the embedded information into encrypted embedded information, such that even if one could re-create the embedded information, one would not be able to create (or re-create) the correct embedded information without knowledge of the encryption keys. In an embodiment of this aspect, information on an identification document thus could be linked together using technology such as public key encryption technology.

In one embodiment, we provide an identification document comprising an OVD and a substrate. The OVD has embedded machine readable data, the embedded machine readable data encrypted with an encryption key. The substrate comprises one or more structures carrying data that is associated with the machine readable data embedded in the OVD. The OVD can comprise comprises at least one of a KINEGRAM and an embossed hologram, and the OVD can have an embedded digital watermark, which itself may carry an issuer identifier. The digital watermark can carry data that is related to other data on the document, and enables authentication of the document by comparison of the data in the digital watermark with other data on the document. This data related to the other data on the document can be encrypted with respect to other data on the document.

In one embodiment, we provide a method of providing security to an identification document having at least one storage element capable of storing information. An encryption key is provided, the encryption key comprising a public key and a private key. An optically variable device (OVD) in a machine readable format is created, the OVD associated with the public key. A payload of data is generated for storage in the storage element. At least a portion of the payload of data is encrypted with the private key, and the encrypted payload of data is transmitted to at least one location on the identification document.

At least a portion of the data payload can be based on data that is randomly selected from data stored in the storage element or that is encrypted from data that is stored in the storage element. The storage element can comprise an optically variable device (OVD), optical storage media, hologram, KINEGRAM, Exelgram, Pixelgram, three dimensional bar code, a two dimensional bar code, a magnetic stripe, and a chip. Transmitting the encrypted payload can comprise at least one of embedding, printing, and encoding encrypted data in at least one location on the identification document. The embedding can include, for example, digital watermarking.

In another aspect, we provide methods for verifying document such as an identification document. In one embodiment, we determine jurisdictional information related to the document, wherein the jurisdictional information is mathematically related to a digital watermark embedded in the document. We can use the jurisdictional information to extract the digital watermark embedded in the document.

In one embodiment, we verify a document by extracting a public key from a machine readable feature on the document, extracting a message payload from another machine readable feature on the document, the message payload being encrypted by a private key that forms part of a public-private key pair with the public key, and using the public key to de-scramble the message payload.

In another embodiment, we verify a document by determining jurisdictional information related to the document, wherein the jurisdictional information is used to obtain a watermark key which is related to a digital watermark embedded in the document and using the key to extract the digital watermark embedded in the document.

The foregoing and other features and advantages of the present invention will be even more readily apparent from the following Detailed Description, which proceeds with reference to the accompanying drawings and the claims.

### BRIEF DESCRIPTION OF THE DRAWINGS

The advantages, features, and aspects of embodiments of the invention will be more fully understood in conjunction with the following detailed description and accompanying drawings, wherein:

FIG. 1 is an illustrative example of an identification document in accordance with an embodiment of the invention;

FIG. 2 illustrates an example of a cross-sectional view of the identification document of FIG. 1, taken along the A-A line, including an OVD security feature and printed ink used to carry other information, such as a photo, text and other security features;

FIG. 3 is a flowchart of a method for implementing encryption, such as public key encryption, into a KINEGRAM® and/or a KINEGRAM containing an embedded digital watermark; and

FIG. 4 is a flowchart of a method for applying a digital watermark to an image to be used in a KINEGRAM.

Of course, the drawings are not necessarily drawn to scale, with emphasis rather being placed upon illustrating the principles of the invention. In the drawings, like reference numbers indicate like elements or steps. Further, throughout this application, certain indicia, information, identification documents, data, etc., may be shown as having a particular cross sectional shape (e.g., rectangular) but that is provided by way of example and illustration only and is not limiting, nor is the shape intended to represent the actual resultant cross sectional shape that occurs during manufacturing of identification documents.

### DETAILED DESCRIPTION

Terminology

In the foregoing discussion, the use of the word “ID document” “identification document” and/or “identification document” is broadly defined and intended to include all types of ID documents, including (but not limited to), documents, magnetic disks, credit cards, bank cards, phone cards, stored value cards, prepaid cards, smart cards (e.g., cards that include one more semiconductor chips, such as memory devices, microprocessors, and microcontrollers), contact cards, contactless cards, proximity cards (e.g., radio frequency (RFID) cards), passports, driver's licenses, network access cards, employee badges, debit cards, security cards, visas, immigration documentation, national ID cards, citizenship cards, social security cards, security badges, certificates, identification cards or documents, voter registration and/or identification cards, police ID cards, border crossing cards, security clearance badges and cards, legal instruments, gun permits, badges, gift certificates or cards, membership cards or badges, and tags. Also, the terms “document,” “card,” “badge” and “documentation” are used interchangeably throughout this patent application.). In at least some aspects of the invention, ID document can include any item of value (e.g., currency, bank notes, and checks) where authenticity of the item is important and/or where counterfeiting or fraud is an issue.

Further, in at least some embodiments, “identification” and “authentication” are intended to include (in addition to the conventional meanings of these words), functions such as recognition, information, decoration, and any other purpose for which an indicia can be placed upon an article in the article's raw, partially prepared, or final state. Also, instead of ID documents, the inventive techniques can be employed with product tags, product packaging, business cards, bags, charts, maps, labels, etc., etc., particularly those items including marking of an laminate or over-laminate structure. The term ID document thus is broadly defined herein to include these tags, labels, packaging, cards, etc.

“Personalization”, “Personalized data” and “variable” data are used interchangeably herein, and refer at least to data, images, and information that are “personal to” or “specific to” a specific cardholder or group of cardholders. Personalized data can include data that is unique to a specific cardholder (such as biometric information, image information, serial numbers, Social Security Numbers, privileges a cardholder may have, etc.), but is not limited to unique data. Personalized data can include some data, such as birthdate, height, weight, eye color, address, etc., that are personal to a specific cardholder but not necessarily unique to that cardholder (for example, other cardholders might share the same personal data, such as birthdate). In at least some embodiments of the invention, personal/variable data can include some fixed data, as well. For example, in at least some embodiments, personalized data refers to any data that is not pre-printed onto an ID document in advance, so such personalized data can include both data that is cardholder-specific as well as data that could be common to many cardholders. Variable data can, for example, be printed on an information-bearing layer of the ID card using thermal printing ribbons and thermal printheads.

As used herein, “printing” refers to any way to provide information to a document, including but not limited to printing using inks, dyes, and toners, as well as using laser engraving, laser etching, laser marking, etc. Virtually any printing method is usable, including but not limited to laser xerography, Indigo, offset printing, intaglio, laser engraving or marking, inkjet printing, thermal or mass transfer printing, dye diffusion thermal transfer (“D2T2”) printing, (described in commonly assigned U.S. Pat. No. 6,066,594, which is incorporated herein by reference in its entirety.), etc.

“Laminate” and “overlaminate” include (but are not limited to) film and sheet products. Laminates usable with at least some embodiments of the invention include those which contain substantially transparent polymers and/or substantially transparent adhesives, or which have substantially transparent polymers and/or substantially transparent adhesives as a part of their structure, e.g., as an extruded feature. Examples of potentially usable laminates include at least polyester, polycarbonate, polystyrene, cellulose ester, polyolefin, polysulfone, polyvinyl chloride (PVC), polyethylene, polypropylene, and polyamide. Laminates can be made using either an amorphous or biaxially oriented polymer as well. The laminate can comprise a plurality of separate laminate layers, for example a boundary layer and/or a film layer. Other possibly usable laminates include security laminates, such as a transparent laminate material with proprietary security technology features and processes, which protects documents of value from counterfeiting, data alteration, photo substitution, duplication (including color photocopying), and simulation by use of materials and technologies that are commonly available. Laminates also can include thermosetting materials, such as epoxy. Laminates can include synthetic resin-impregnated or coated base materials composed of successive layers of material, bonded together via heat, pressure, and/or adhesive.

The material(s) from which a laminate is made may be transparent, but need not be. The degree of transparency of the laminate can, for example, be dictated by the information contained within the identification document, the particular colors and/or security features used, etc. The thickness of the laminate layers is not critical, although in some embodiments it may be preferred that the thickness of a laminate layer be about 1-20 mils. Lamination of any laminate layer(s) to any other layer of material (e.g., a core layer) can be accomplished using any conventional lamination process, and such processes are well known to those skilled in the production of articles such as identification documents. Of course, the types and structures of the laminates described herein are provided only by way of example, those skilled in the art will appreciated that many different types of laminates are usable in accordance with the invention. Various lamination processes are disclosed in assignee's U.S. Pat. Nos. 5,783,024, 6,007,660, 6,066,594, and 6,159,327. Other lamination processes are disclosed, e.g., in U.S. Pat. Nos. 6,283,188 and 6,003,581. Each of these U.S. patents is herein incorporated by reference.

For purposes of illustration, the following description will proceed with reference to ID document structures (such as TESLIN-core, multi-layered ID documents, polycarbonate core ID documents, etc.) and fused polycarbonate structures. It should be appreciated, however, that the present invention is not so limited. Indeed, as those skilled in the art will appreciate, the inventive techniques can be applied to many other structures formed in many different ways to provide secure information thereon.

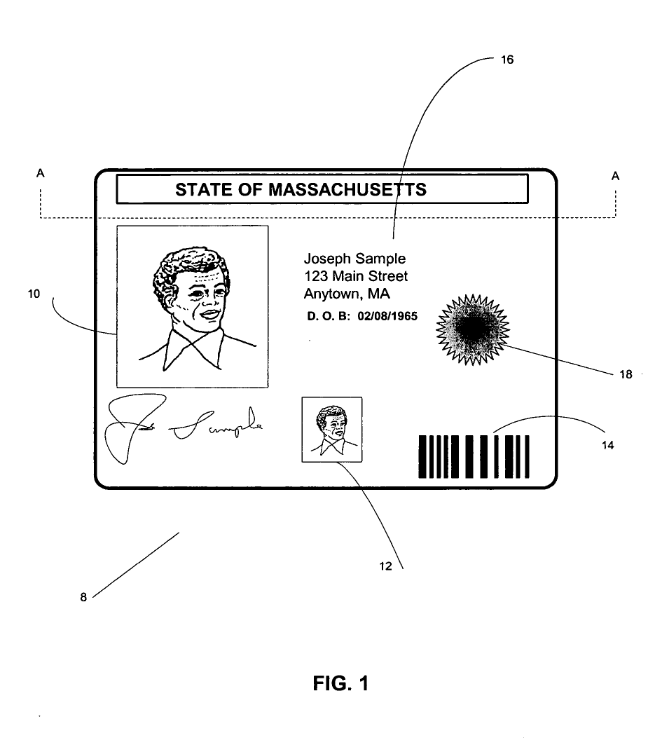

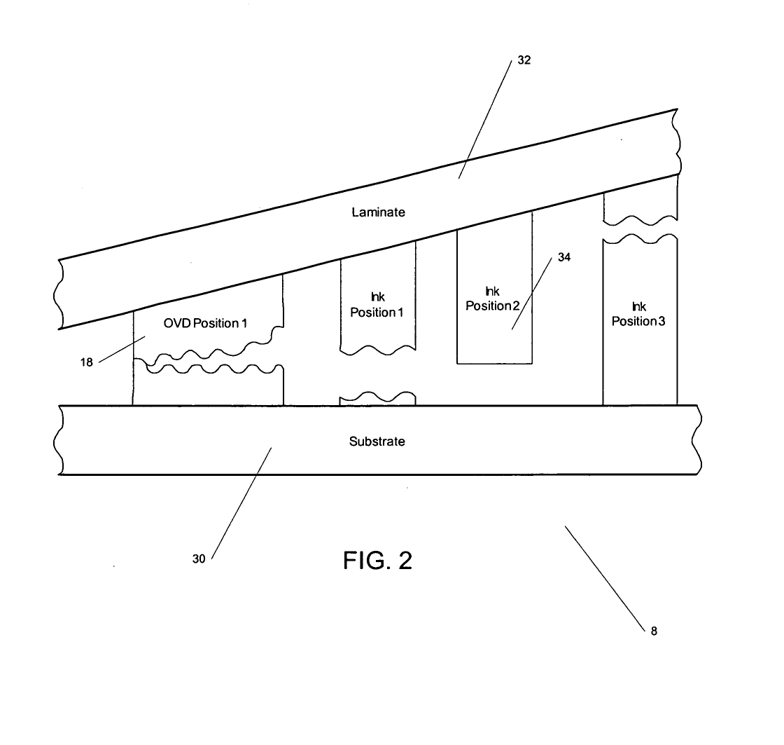

FIGS. 1 and 2 are illustrative straight on cross sectional and straight on views, respectively of an Identification document 8 in accordance with an embodiment of the invention. FIG. 1 illustrates an example of an Identification document, including an OVD security feature and printed ink used to carry other information, such as a photo, text and other security features, in accordance with one embodiment of the invention. In this example, the identification document is an identification card (which may or may not include a photograph or other identification quality image of the card holder) comprising an OVD (e.g., a KINEGRAM® OVD with embedded data), a substrate, ink that is printed on the substrate, and one or more layers of laminate covering the ink. The ink printed on the substrate carries text, a photo image, and possibly other security structures.

Referring to FIGS. 1 and 2, the identification document 8 can be formed using a core material 30 such as PVC, TESLIN, or polycarbonate (PC), and can be laminated with a substantially clear laminate 32. The identification document 8 can include, for example, a portrait of the cardholder 10, a ghost image 12, a two or three dimensional bar code 14, variable data such as a cardholder address and birthdate 16, a magnetic stripe (not shown in FIG. 1 or 2 but often found on the rear side of an identification card) and an optically varying device (OVD) feature 18, such as a KINEGRAM®. Note that the OVD 18 of FIG. 1 is shown as being on a part of the identification document such that it does not directly overlay variable information on the document, but the invention is not so limited. In at least one embodiment, for example, the location of the OVD 18 can coincide with at least some variable data on the card (e.g., data that can vary from user to use and/or from card to card, such as the portrait 10) in such a way as to protect against manipulation and/or alteration of the variable data (e.g., by swapping photos, altering demographic data, etc.) by methods such as intrusion or simulation. As those skilled in the art appreciate, OVDs can be substantially translucent or transparent, such that they can overlay data while permitting it to be visible.

Any one or more of the images printed on the identification document 8 (e.g., portrait 10, ghost image 12) can be embedded with at least one type of a machine readable code, such as by one or more digital watermarks. The OVD can also be embedded with one or more digital watermarks.

The digital watermark may carry data, such as a key or document identifier that is either used to extract other data or compared with other data on the identification document. For example, the digital watermark in the OVD may carry a key that is necessary to decode another digital watermark embedded in an image printed on the document, such as a photo or background image. The digital watermark may carry information, such as a bearer name or hash of bearer data, printed elsewhere on the card or carried in another machine readable feature, such as a digital watermark, magnetic stripe, RF ID, smart card, chip, 2D bar code, or 3D bar code (an example of the latter is described more fully in a commonly assigned application entitled “Methods and Devices for Providing Three Dimensional Bar Codes”, Ser. No. 60/463,660, inventors Robert Jones and Brian Labrec, filed on Apr. 16, 2003, the contents of which are hereby incorporated by reference).

A digital watermark may carry virtually any type of information associated with a given identification document. This can be especially advantageous with new technologies for the creation of machine readable data. For example, consider technology such as a bar code containing embedded particles (e.g., nanoparticles), as described in an online article of NATURE magazine, dated Oct. 30, 2003 and found at http://www.nature.com.nsu/031027/031027-7.html. In this technology, each barcode line contains atoms of permalloy (an iron-nickel mixture), where the printed lines arranges these magnetic particles in unique patterns, each pattern having a measurable, unique magnetic field. This nanoparticle material can be used on areas such as the barcodes of identification documents (or on other parts of the identification document) and a quantitative measurement of the unique magnetic pattern can be taken and encoded as a machine readable signature. For example, the nanoparticle material can be used as a coating on all or part of an identification document, creating a unique machine readable magnetic signature that can then can be stored in a data carrier on the identification document itself (e.g., encoded into a KINEGRAM, stored on a smart card chip, encoded into a digital watermark, stored in an external database, etc.), and encrypted, if desired. Later, during authentication, the unique machine readable magnetic signature information stored about the nanoparticle material can be retrieved and compared with a reading from the location(s) of the actual nanoparticle material, to check the authenticity of the identification document.

With any of the above described systems, if the relationship between the cross-referenced data on the identification document is broken, either by tampering the OVD or other data, an automatic verification detects this tampering by finding a mismatch in the data or being unable to extract the embedded data.

In at least some embodiments, the identity card is constructed such that attempts to remove and substitute or alter the OVD and other structures in the card result in damage of the OVD and/or the structures. For example, by making the OVD and/or other structures fragile to this type of tampering, such as by using tamper evident inks and/or adhesives, the validity of the card can be checked by examining the OVD and/or structures for visible signs of destruction, and by attempting to read the embedded data, such as laser readable or watermark in these structures automatically. If the OVD or printed structures are altered, automatic reading of embedded data will fail, indicating that the card is invalid. This effect may be accomplished by choosing an adhesive or set of adhesives that bonds the OVD and ink to the laminate and substrate such that the OVD and ink break apart as shown in FIG. 1 if the laminate and substrate are separated. For more information on this approach, see U.S. Pat. No. 5,380,695, and co-pending application Ser. No. 10/329,315, which are hereby incorporated by reference.

In another embodiment of the invention, the OVD comprises a Kinegram with a digital watermark (or other machine readable technology) containing at least a portion of a public key necessary for reading data contained elsewhere on the identification document, such as data contained in a digital watermark of a photo, 2D/3D barcode, smart card, chip, RFID (RF Identification), OCR (optical character recognition), biometric feature (e.g., fingerprint), etc., or containing other machine readable data on the card.

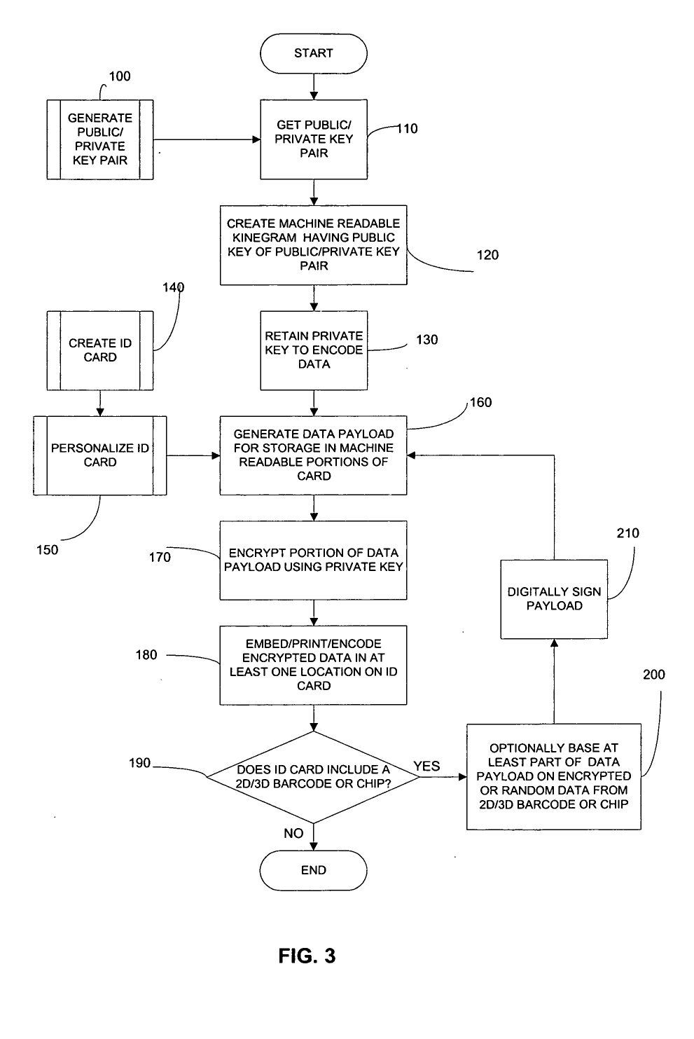

FIG. 3 is a flowchart of a first method for implementing encryption, such as public key encryption, into a KINEGRAM® and/or a KINEGRAM containing an embedded digital watermark. For purposes of illustration only, the following discussion will proceed using the example of an identification document that is a card issued by an issuing organization, where the identification document includes variable information and preferably includes a portrait of the cardholder (examples of such documents include driver's licenses, national identification cards, voter identification cards, and the like). Of course, those skilled in the art will appreciate that the invention has application to many other types of identification documents and other documents.

Referring again to FIG. 3, a Public Key and Private Key pair is generated (step 100). The Public/Private key pair can, for example, be used for a particular jurisdiction or set of jurisdictions for a known period of time.

Using the Public/Private key pair (step 110), a Kinegram in a machine readable format is created (step 120). The Kinegram has all or all or part of the Public Key necessary for reading the data to be embedded.

The private key is retained (step 130) to encode the data. The ID card is created (step 140) through any method known in the art, and is personalized (step 150). During card personalization, the data payload that is intended for storage in the machine readable portions of the card is generated (step 160). For example, in one embodiment, during card personalization the payload that is intended for storage in a digital watermarked portrait is generated, as well as payloads intended for storage in other digital watermarks that may be on a card. In one embodiment, during card personalization the payload intended for storage in another data storing element of the ID card, such as a 2D/3D barcode, chip, RFID, magnetic stripe, etc., also can be generated in step 160.

At least a portion of the data payload is encrypted using the Private key (step 170). In at least one embodiment, a significant portion of the data payload is encrypted using the Private key. In at least one embodiment, if the data payload is small, the entire payload is encrypted using the Private key.

The encrypted data is then embedded, printed, or encoded in one or more locations on the ID document (step 180). In at least one embodiment, the non-encrypted data is also embedded, printed, or encoded into one or more locations on the ID document, as well.

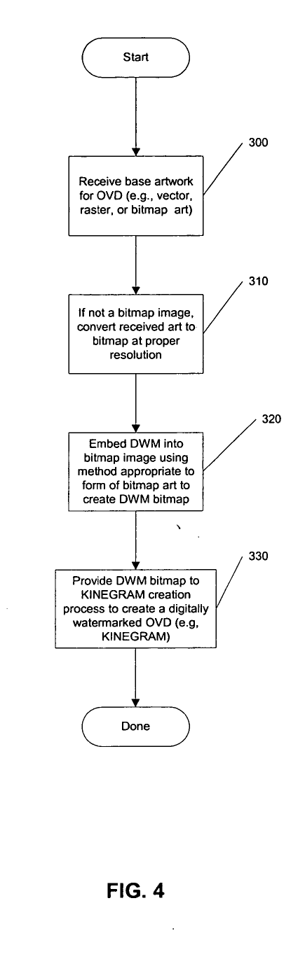

In one embodiment, the encrypted data can be embedded into an OVD on the identification document by embedding a digital watermark into the OVD. FIG. 4 is a generalized method for embedding a digital watermark (DWM) into a KINEGRAM, but those skilled in the art will appreciate that this embedding method is applicable to many other types of OVDS and can be adapted to work with virtually any storage element or device. Referring to FIG. 4, the basic artwork for the given KINEGRAM is received (step 300). This art can be in virtually any format, e.g., vector artwork, raster artwork, bitmap artwork, etc. The art is converted to a bitmap image (if it is not a bitmap image already) (step 310). As those skilled in the art appreciate, the required resolution of the bitmap image can depend, at least in part, on the specific technique that is used in step 320 for digitally watermarking the image. And, furthermore, the specific technique for digitally watermarking the bitmapped image (step 320) can depend at least partially on the type of art of the original image (step 300).

For example, some KINEGRAM images are based on an original vector image having artwork consisting of many fine lines. Such an image can be digitally watermarked using, for example, systems and methods described in the following commonly assigned patents, each of which is incorporated by reference. “Digital watermarks and methods for security documents,” U.S. Pat. No. 6,345,105, inventor Geoffrey B. Rhoads, issued Feb. 5, 2002, and “Methods and systems for watermark processing of line art images,” U.S. Pat. No. 6,449,377, inventor Geoffrey B. Rhoads, issued Sep. 10, 2002.

Referring again to FIG. 4, the digitally watermarked bitmap image is then ready to be embedded into the KINEGRAM or other OVD or storage element (step 330). Systems and methods for embedding DWM images into OVDs such as KINEGRAMS are described further in the following commonly assigned patents and applications, each of which is hereby incorporated by reference: “Watermarking Holograms,” Ser. No. 09/741,779, inventors Stephen K. Decker, Hugh L. Brunk, and J. Scott Carr, filed Dec. 21, 2000, and “Digitally Watermarking Holograms for Use With Smart Cards,” Ser. No. 09/923,732, inventors Neil Lofgren, Stephen K. Decker, Hugh L. Brunk, and J. Scott Carr (now issued U.S. Pat. No. 6,608,911, issued on Aug. 19, 2003).

In at least one embodiment of the invention, for identification documents containing information storing elements such as 2D/3D barcodes, chips, etc. (step 190), the security of the system may be increased by selecting encrypted or random data from the information storing element and using that encrypted or random data in the machine readable technology, such as the digital watermark (step 200). For example, in one embodiment, data in a digital watermark that is associated with variable data is based on encrypted or random data from a 2D/3D barcode, magnetic stripe, or chip. In one embodiment, the encrypted or random data can be digitally signed using an algorithm such as the standard DSA algorithm.

Of course, alternative implementations of the invention can use other types of data in the KINEGRAM to tie this data to other data storage areas on the identification document and/or other digital watermarks on the card. In accordance with embodiments of the invention, there are a variety of ways of using encryption or a similar randomization process to tie data in security elements together.

For example, in one embodiment, all or part of the public key for one data-carrying element is embedded in another data carrying element (e.g., digital watermark, smart card, laser readable media, machine readable optically variable device, bar code, magnetic stripe, etc.).

In another exemplary embodiment, random data (e.g., purely random or pseudo random data generated by a pseudo random number generator seeded by a key) is XOR'd or otherwise mathematically combined with data carried in one security element to produce data encoded in another security element,

In a further embodiment, jurisdiction data (e.g., data associated with an issuer of an identification document) is mathematically combined with or stored in/with data in one security element is encoded in another security element.

In a third aspect of the invention, the implementation of the second aspect of the invention is part of an identification system having a plurality of different Kinegram “masters”, each Kinegram master associated with different machine readable codes (e.g., digital watermarks) containing different keys. In this aspect, it is possible to use different Kinegram on cards, (including randomly) where the Kinegram machine readable technology (e.g., digital watermark) is known to match the machine readable technology (e.g., watermark) in the some variable data (e.g., the portrait) on an identification document. This can add security because it can limit the chance that a substituted or bogus Kinegram can provide a usable key for reading the machine readable data (e.g., digital watermark).

In an alternative implementation of the invention, jurisdictional information is used as a digital watermarking key, instead of an encryption key, to help decode a digital watermark. A watermark key in this context reveals some secret about a watermark or watermark embedding or decoding process. For example, the key reveals information about a watermarking protocol, a watermark embedding/decoding characteristic and/or a watermark payload encryption key. In one implementation a key provides a pseudo-random sequence that is used to embed the watermark. In another example, a key specifies locations for watermark embedding, host signal features to be modified to effect embedding, and/or semantic meaning of particular features (e.g., how modifications to the host signal are mapped to particular data symbols, such as binary or M-ary symbols), etc., etc. The jurisdictional information can be used as an index to locate an appropriate key. Or the jurisdictional information can be combined with other data to form a key. Still further, the jurisdictional information itself can be used as a watermarking key.

Another example is to link machine-readable information from another data carrying area of the identification document, such as a smart card chip, optical media, or laser engraved area, to help decode a digital watermark. In one implementation we provide a reader which images the card to capture both the laser engraved area and an area including a digital watermark. (Sometimes these areas overlap, or a digital watermark is provided through the laser engraving.) The reader preferably captures the laser engraved area and the digitally watermarked area using a single optical scanner, but the present invention is not so limited. The machine-readable information of the laser engraved area includes a watermark key (or encryption key), which is used to decode the watermark (or to be paired with, e.g., a public key for decrypting auxiliary information). The curious reader is referred to U.S. patent application Ser. Nos. 10/330,033 and 60/456,677, which are each herein incorporated by reference, for related methods and/or environments.

Instead of laser engraving, an optical memory card, like that provided by LaserCard Systems Corporation, headquartered in Mountain View, Calif. (e.g., via their LaserCard and LaserCard 600-Q Optical Card Drive) can be used to provide machine-readable information, which can carry a key to decode, decrypt or help find a digital watermark. (LaserCard's promotional material suggests that its optical memory card contains a reflective optical recording medium sandwiched between transparent, protective layers. Information is stored n the card as a binary code, where ones and zeros are represented by either the presence or absence of physical “spots” on the recording media. The spots are tiny—as small as 2.25 microns.) In some case we align an imagining sensor so that both optically recorded information and a digital watermark can be read by the same imagining sensor.

The usefulness of these and other embodiments of the invention can be further understood by imagining the following scenarios.

First, suppose that a Kinegram were taken from one real/authentic card and put into another. In that instance, the counterfeit attempt should fail. In this example, using information and embodiments of the invention described herein, the counterfeit will not be created using the Private Key necessary for creating readable data. If the variable data (e.g., photo) were taken from a real identification document and the machine readable technology (e.g., digital watermark) in the variable data does not contain data from the data storing element on the identification document (e.g., 2D/3D barcode or chip), then it would still match the Kinegram since they are both the same as the original. However, variable data (e.g., a portrait) printed by the counterfeiter would not work. Since the Kinegram is real in this case it will only match a photo copied from a real document, the data encoded in the photo will not be alterable.

Next, suppose that a Kinegram were stolen—then used to make a counterfeit card. In that instance, as well, the counterfeit attempt should fail. In this example, using the information and embodiments of the invention described herein, the counterfeiter would still need to generate variable data (e.g., a photo) with the machine readable code (e.g., digital watermark) matching the Kinegram and possibly another data storing element (e.g., 2D/3D Barcode, magnetic stripe, chip) with the correct encrypted data. Lack of knowledge of the private key would make generating useful data nearly impossible. If three major data elements are tied together using a full DSA certificate then it could be impossible to alter or swap any one of the elements without knowledge of the Private (secret) key.

Next, assume that a counterfeit Kinegram was used to create a counterfeit license. In this example, using the information and embodiments of the invention described herein, the counterfeit attempt should fail even with a so-called “really convincing” bogus or fake Kinegram. In accordance with at least some embodiments of the invention described herein, a counterfeit Kinegram should be impossible due to the lack of knowledge of the keys necessary to embed the machine readable technology (e.g., digital watermark) containing the read key for the document itself. If the key in the Kinegram were not readable, it would be a clear indication of the counterfeit.

For more information about the application of OVDs, and specifically KINEGRAM® OVDs, with embedded data for authentication of identification documents, see Appendix A, entitled “Information Response AAMVA Unique Identifier Response,” by Digimarc ID Systems, which is hereby incorporated by reference.

Of course, in all of the examples and embodiments described herein, the substrate and/or laminate of the identification document may be made of many different types of materials, including but not limited to resins, polyesters, polycarbonates, vinyls, acrylates, urethanes, and cellulose based materials, thermosetting material, thermoplastic, polymer, copolymer, polycarbonate, fused polycarbonate, polyester, amorphous polyester, polyolefin, silicon-filled polyolefin, TESLIN, TYVEC, plastic paper, paper, synthetic paper, foamed polypropylene film, polyvinyl chloride, polyethylene, thermoplastic resins, engineering thermoplastic, polyurethane, polyamide, polystyrene, expanded polypropylene, polypropylene, acrylonitrile butadiene styrene (ABS), ABS/PC, high impact polystyrene, polyethylene terephthalate (PET), PET-G, PET-F, polybutylene terephthalate PBT), acetal copolymer (POM), polyetherimide (PEI), polyacrylate, poly(4-vinylpyridine, poly(vinyl acetate), polyacrylonitrile, polymeric liquid crystal resin, polysulfone, polyether nitride, and polycaprolactone.

One source for OVDs suitable for this application is OVD Kinegram AG, a member of the Kurz Group. Other types of embossed OVDs may be used as well if they meet the design constraints for the particular secure document application. Advantageously, the OVD should have a high index of refraction. It may be transparent, but need not be.

Concluding Remarks

Having described and illustrated the principles of the technology with reference to specific implementations, it will be recognized that the technology can be implemented in many other, different, forms. To provide a comprehensive disclosure without unduly lengthening the specification, applicants incorporate by reference the patents and patent applications referenced above.

The methods, processes, and systems described above may be implemented in hardware, software or a combination of hardware and software. For example, the auxiliary data embedding processes may be implemented in a programmable computer or a special purpose digital circuit. Similarly, auxiliary data reading and authentication using other data on an identification document may be implemented in software, firmware, hardware, or combinations of software, firmware and hardware. The methods and processes described above may be implemented in programs executed from a system's memory (a computer readable medium, such as an electronic, optical or magnetic storage device).

The technology disclosed herein can be used in combination with other technologies. Also, instead of ID documents, the inventive techniques can be employed with product tags, product packaging, labels, business cards, bags, charts, smart cards, maps, labels, etc., etc. The term ID document is broadly defined herein to include these tags, maps, labels, packaging, cards, etc.

It should be appreciated that while FIGS. 1 and 2 illustrate a particular species of ID document—a driver's license—the present invention is not so limited. Indeed our inventive methods and techniques apply generally to all identification documents defined above. Moreover, our techniques are applicable to non-ID documents, e.g., such as printing or forming covert images on physical objects, papers, currency, checks, etc. Further, instead of ID documents, the inventive techniques can be employed with product tags, product packaging, business cards, bags, charts, maps, labels, etc., etc., particularly those items including providing a non-visible indicia, such as an image information on an over-laminate structure. The term ID document is broadly defined herein to include these tags, labels, packaging, cards, etc. In addition, while some of the examples above are disclosed with specific core components, it is noted that-laminates can be sensitized for use with other core components. For example, it is contemplated that aspects of the invention may have applicability for articles and devices such as compact disks, consumer products, knobs, keyboards, electronic components, decorative or ornamental articles, promotional items, currency, bank notes, checks, etc., or any other suitable items or articles that may record information, images, and/or other data, which may be associated with a function and/or an object or other entity to be identified.

The technology and solutions disclosed herein have made use of elements and techniques known from the cited documents. Other elements and techniques from the cited documents can similarly be combined to yield further implementations within the scope of the present invention. Thus, for example, single-bit watermarking can be substituted for multi-bit watermarking, technology described as using imperceptible watermarks or encoding can alternatively be practiced using visible watermarks (glyphs, etc.) or other encoding, local scaling of watermark energy can be provided to enhance watermark signal-to-noise ratio without increasing human perceptibility, various filtering operations can be employed to serve the functions explained in the prior art, watermarks can include subliminal graticules to aid in image re-registration, encoding may proceed at the granularity of a single pixel (or DCT coefficient), or may similarly treat adjoining groups of pixels (or DCT coefficients), the encoding can be optimized to withstand expected forms of content corruption, etc. Thus, the exemplary embodiments are only selected samples of the solutions available by combining the teachings referenced above. The other solutions necessarily are not exhaustively described herein, but are fairly within the understanding of an artisan given the foregoing disclosure and familiarity with the cited art. The particular combinations of elements and features in the above-detailed embodiments are exemplary only; the interchanging and substitution of these teachings with other teachings in this and the incorporated-by-reference patent documents are also expressly contemplated.

The particular combinations of elements and features in the above-detailed embodiments are exemplary only; the interchanging and substitution of these teachings with other teachings in this and the incorporated-by-reference patents/applications are also contemplated.

1. An identification document comprising:
an OVD with embedded machine readable data, the embedded machine readable data encrypted with an encryption key;
a substrate comprising one or more structures carrying data that is associated with the machine readable data embedded in the OVD.

2. The document of claim 1 wherein the OVD comprises at least one of a KINEGRAM® and an embossed hologram, the OVD having an embedded digital watermark.

3. The document of claim 2 wherein the digital watermark carries at least one of an issuer identifier and a machine readable signature related to at least one other element of the identification document.

4. The document of claim 3, wherein the identification document further comprises nanoparticle material having a unique machine readable magnetic signature and wherein the digital watermark carries information relating to the unique readable magnetic signature.

5. The document of claim 2 wherein the digital watermark carries data that is related to other data on the document, and enables authentication of the document by comparison of the data in the digital watermark with other data on the document.

6. The document of claim 5 wherein the data related to the other data on the document is encrypted with respect to other data on the document.

7. A method of providing security to an identification document having at least one storage element capable of storing information, comprising:
providing an encryption key, the encryption key comprising a public key and a private key;
creating an optically variable device (OVD) in a machine readable format, the OVD associated with the public key;
generating a payload of data for storage in the storage element;
encrypting at least a portion of the payload of data with the private key; and
transmitting the encrypted payload of data to at least one location on the identification document.

8. The method of claim 7, wherein generating a payload of data further comprises basing at least a portion of the data payload on data that is randomly selected from data stored in the storage element.

9. The method of claim 7, wherein generating a payload of data further comprises basing at least a portion of the data payload on data that is encrypted from data that is stored in the storage element.

10. The method of claim 7, wherein the storage element comprises at least one of an optically variable device (OVD), optical storage media, hologram, KINEGRAM, Exelgram, Pixelgram, three dimensional bar code, a two dimensional bar code, a magnetic stripe, and a chip.

11. The method of claim 7, wherein transmitting the encrypted payload comprises at least one of embedding, digitally watermarking, printing, and encoding encrypted data in at least one location on the identification document.

12. An identification document comprising:
an OVD with embedded machine readable data;
a substrate with one or more structures carrying data that is associated with the machine readable data embedded in the OVD.

13. The document of claim 12 wherein the OVD comprises an embossed hologram with an embedded digital watermark.

14. The document of claim 13 wherein the digital watermark carries an issuer identifier.

15. The document of claim 13 wherein the digital watermark carries data that is related to other data on the document, and enables authentication of the document by comparison of the data in the digital watermark with other data on the document.

16. A method of verifying a document comprising:
determining jurisdictional information related to the document, wherein the jurisdictional information is mathematically related to a digital watermark embedded in the document; and
using the jurisdictional information to extract the digital watermark embedded in the document.

17. A method of verifying a document comprising:
extracting a public key from a machine readable feature on the document;
extracting a message payload from another machine readable feature on the document, the message payload being encrypted by a private key that forms part of a public-private key pair with the public key; and
using the public key to de-scramble the message payload.

18. The method of claim 17 wherein at least one of the machine readable features comprises an optically variable device.

19. The method of claim 17 wherein at least one of the machine readable features comprises a digital watermark.

20. The method of claim 17 wherein the message payload comprises a digital watermark message payload, and the public key is stored in a machine readable optically variable device.

21. A method of verifying a document comprising:
determining jurisdictional information related to the document, wherein the jurisdictional information is used to obtain a watermark key which is related to a digital watermark embedded in the document; and
using the key to extract the digital watermark embedded in the document.

22. The method of claim 21, wherein the document comprises a machine-readable feature, which carries the jurisdictional information, and wherein said determining step comprises reading the machine-readable feature.

23. The method of claim 21, wherein the jurisdictional information comprises an index, which is used to interrogate a database to obtain the watermarking key.

24. The method of claim 21, wherein the jurisdictional information is combined with predetermined data to form the watermarking key.

25. The method of claim 21, wherein the jurisdictional information comprises the watermarking key.

26. The method of claim 22, wherein the jurisdictional information comprises the watermarking key.

27. The method of claim 21, wherein the jurisdictional information is mathematically related to the digital watermark through a cryptographic relationship.

28. The method of claim 21, wherein the jurisdictional information is mathematically related to the digital watermark through a watermarking key.
